(19) United States
(12) Patent Application Publication
(10) Pub. No.: US 2013/0074701 A1
(43) Pub. Date: Mar. 28, 2013

(54) FOOD PROCESSOR AND MOTOR ASSEMBLY

(71) Applicant: Johnson Electric S.A., Murten (CH)

(72) Inventors: Yue Hua ZHAO, Shatin (HK); Siu Wing LEE, Shatin (HK); Yui Ko WONG, Shatin (HK)

(73) Assignee: Johnson Electric S.A., Murten (CH)

(21) Appl. No.: 13/626,651

(22) Filed: Sep. 25, 2012

(30) Foreign Application Priority Data
Sep. 26, 2011 (CN) 201110289057.4

(51) Int. Cl. A47J 37/01; H02K 7/116; B01F 7/00

(52) U.S. Cl. 99/348; 366/314; 310/83

(57) ABSTRACT

A food processor has a container, a working piece for processing food material in the container, and a motor assembly for driving the working piece. The motor assembly includes an electric motor and a speed reduction gear unit connected between the motor and the working piece. The speed reduction gear unit includes a damper for isolating the motor from vibrations from the working piece.

### CROSS REFERENCE TO RELATED APPLICATIONS

This non-provisional patent application claims priority under 35 U.S.C. §119(a) from Patent Application No. 201110289057.4 filed in The People's Republic of China on Sep. 26, 2011.

### FIELD OF THE INVENTION

This invention relates to a food processor and in particular, to a motor assembly for the food processor.

### BACKGROUND OF THE INVENTION

US2003/0145737A1 discloses a bread maker which includes a casing, a mixing rod, a baking oven, a bread making chamber unit, and an electrical heating tube. The mixing rod is driven by a motor unit. The motor unit includes an alternating current motor and a speed reduction gear unit. The speed reduction gear unit comprises a transmission gear and a gear case. The transmission gear is engaged with a gear shaft of the motor. The power of the motor is transmitted to a rotating fork which in turn rotates the mixing rod. The above bread maker has some disadvantages. Firstly, the height of the bread maker is relatively large. Secondly, the vibration on the mixing rod will be transmitted to the shaft of the motor, which brings negative influence on the performance of the motor.

### SUMMARY OF THE INVENTION

In one aspect thereof, the present invention provides a motor assembly, comprising an electric motor and a speed reduction gear unit driven by the motor, the speed reduction gear unit comprising a main shaft and an output unit, wherein the main shaft comprises a metal body and an thermal insulating portion formed on the metal body, the output unit being at least partly sleeved on the thermal insulating portion to prevent heat on the output unit from being transmitted to the metal body.

Preferably, the thermal insulating portion is over-molded on the metal body.

Preferably, the output unit comprises a first member and a second member engaged with the first member, the second member being made of metal and sleeved on the thermal insulating portion.

Preferably, the first member is made of low heat resistant material.

Preferably, a sealing ring is received inside the first member and tightly sleeved on the main shaft.

In a second aspect thereof, the present invention provides a food processor, comprising: a container; a working piece for processing food material in the container; and a motor assembly for driving the working piece, the motor assembly comprising an electric motor and a speed reduction gear unit connected between the motor and the working piece; wherein the speed reduction gear unit comprises a damper for isolating the motor from vibrations from the working piece.

Preferably, the speed reduction gear unit further comprises a stationary main shaft, and a toothed wheel and an output unit which are rotatably sleeved on the main shaft, the damper being axially arranged between the toothed wheel and the output unit and transmitting the rotation of the toothed wheel to the output unit.

Preferably, the motor has a worm shaft and the toothed wheel is engaged with the worm shaft.

Preferably, the main shaft comprises a metal body and a thermal insulating portion on the metal body, the output unit being at least partly sleeved on the thermal insulating portion.

Preferably, the output unit comprises a first member and a second member separately formed and engaged with the first member, the second member being made of metal and sleeved on the thermal insulating portion, and the toothed wheel is made of low heat resistant material.

Preferably, the first member is coupled to the damper.

Preferably, a sealing ring is received inside the first member and tightly sleeved on the main shaft.

Preferably, a plurality of small protrusions project from one axial end surface of the damper facing the output unit to contact an adjacent axial end surface of the output unit.

Preferably, a sealing ring is received inside the first member and tightly sleeved on the main shaft.

In a third aspect thereof, the present invention provides a bread maker, comprising: a casing; a container arranged in the casing; a baking chamber with a heater for heating the container; a kneading tool rotatably disposed in the container for kneading bread material; and a motor assembly comprising an electric motor and a speed reduction gear unit connected between the motor and the kneading tool; wherein the motor has a worm shaft, and the speed reduction gear unit has a worm wheel and a main shaft, the worm wheel being sleeved on the main shaft and engaged with the worm shaft.

Preferably, the kneading tool is coaxial with the main shaft.

Preferably, the speed reduction gear unit comprises a damper for isolating the motor from vibrations from the kneading tool.

Preferably, the speed reduction gear unit further comprises an output unit, wherein the main shaft is stationary and the worm wheel and the output unit are rotatably sleeved on the main shaft, and the damper is disposed between the worm wheel and the output unit to transfer the rotation of the worm wheel to the output unit.

Preferably, the main shaft comprises a metal body and a thermal insulating portion formed on the metal body, the output unit being at least partly sleeved on the thermal insulating portion.

Preferably, the output unit comprises a first member and a second member separately formed and engaged with the first member, the second member being made of metal and sleeved on the thermal insulating portion, and the worm wheel is made of low heat resistant material, and the first member is coupled to the worm wheel via the damper.

Preferably, a plurality of small protrusions project from one axial end surface of the damper facing the output unit to contact an adjacent axial end surface of the output unit.

### BRIEF DESCRIPTION OF THE DRAWINGS

Preferred embodiments of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 is a partially sectioned view of a bread maker in accordance with a preferred embodiment of the present invention;

FIG. 2 is a view of a motor assembly, being a part of the bread maker of FIG. 1;

FIG. 3 is an exploded view of a speed reduction gear unit being a part of the motor assembly of FIG. 2;

FIG. 4 is a sectional view of the motor assembly of FIG. 2; and

FIG. 5 is another exploded view of the speed reduction gear unit of FIG. 3, with a gearbox housing and a gearbox cover omitted.

### DETAILED DESCRIPTION OF THE PREFERRED EMBODIMENTS

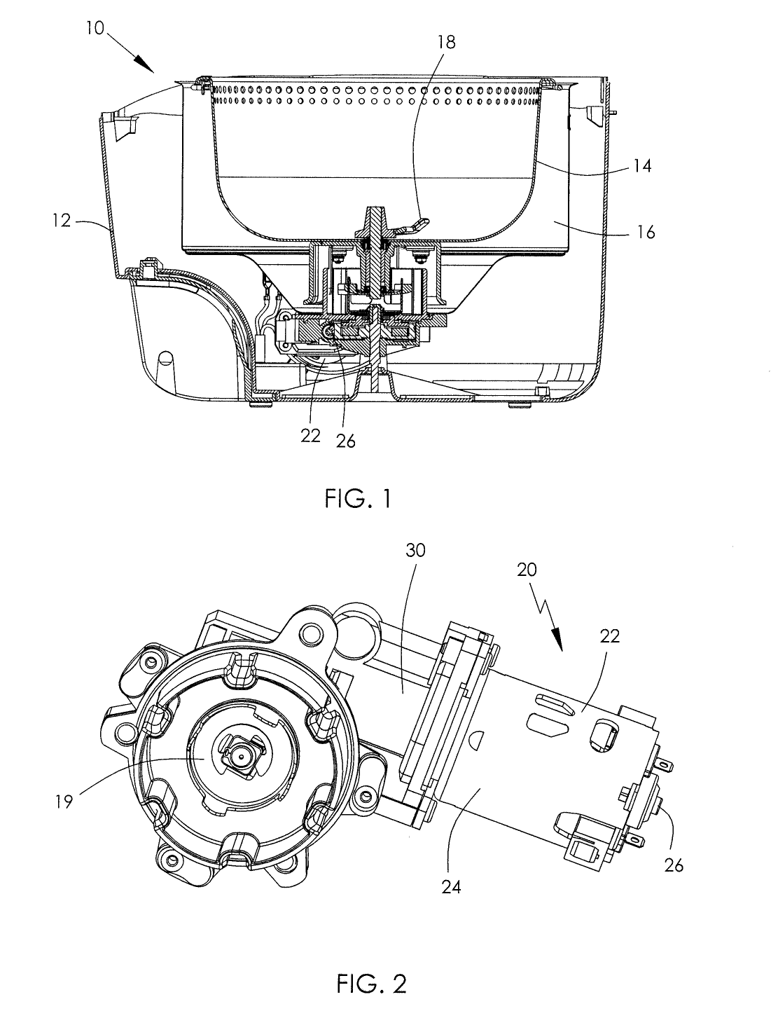

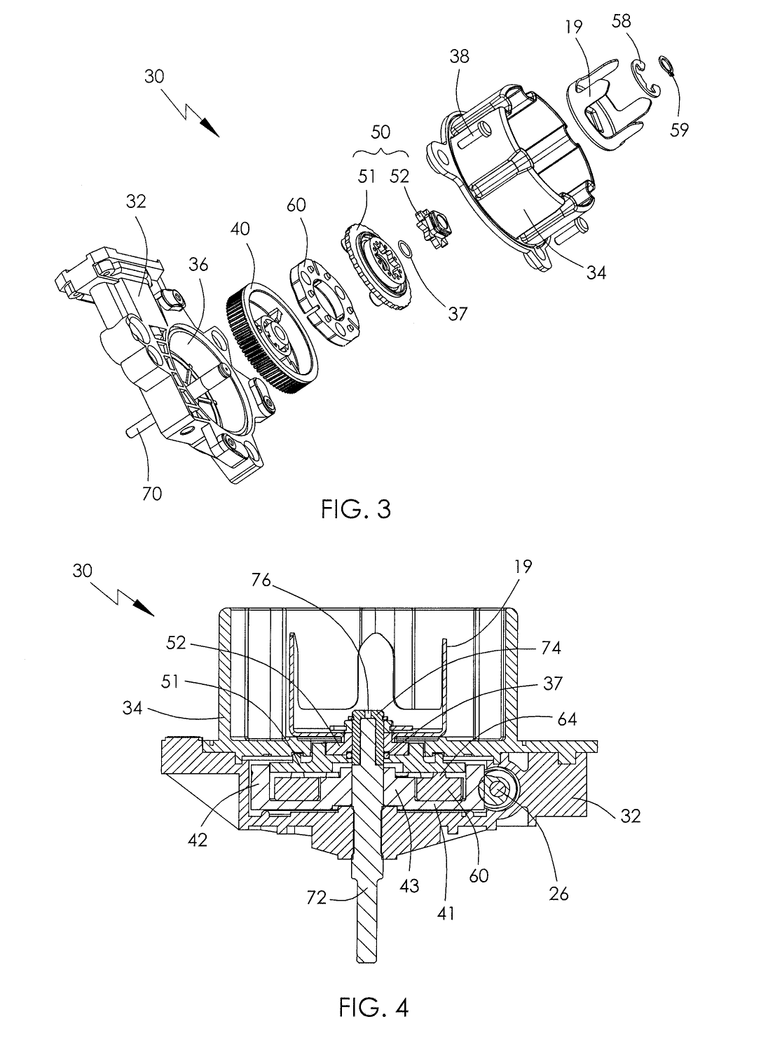

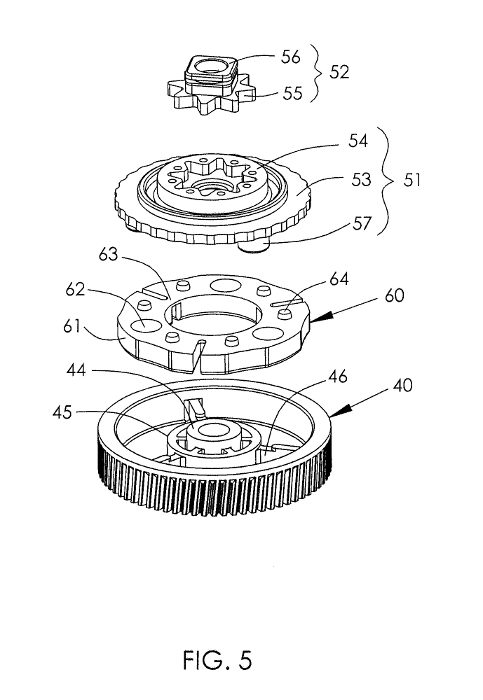

FIG. 1 illustrates a bread maker 10 in accordance with a preferred embodiment of the present invention. The bread maker 10 is shown partially sectioned and includes a casing 12, a lid (not shown), a container 14 arranged in the casing 12, a baking chamber 16, a heater (not shown) arranged with the baking chamber 16 for heating the container 14, a kneading tool 18 rotatably disposed in the container 14 for kneading bread material, and a motor assembly 20 for driving the kneading tool 18.

The motor assembly 20 includes an electric motor 22 and a speed reduction gear unit 30. Preferably, the electric motor 22 is a high voltage direct current motor.

The reduction gear unit 30 includes a gearbox housing 32, a gearbox cover 34, a worm wheel 40, an output unit 50, a damper 60 and a main shaft 70. The gearbox housing 32 is fixed to the housing 24 of the motor 22 and has a circular recess 36. The gearbox cover 34 is fixed to the gearbox housing 32 via screws 38.

The worm wheel 40 is rotatably received in the recess 36 of the gearbox housing 32 and includes a circular base wall 41 with a central hole, a annular flange 42 axially extending from the outer periphery of the base wall 41, and a hub 43. The hub 43 has a shaft sleeve portion 44 coaxially extending from the inner surface of the central hole of the base wall 41 and an outer ring 45 surrounding the shaft sleeve portion 44. A plurality of teeth are formed on the outer surface of the flange 42 to engage with a worm shaft 26 of the motor 22 such that the motor 22 drives the worm wheel 40 to rotate at a speed lower than the speed of the worm shaft 26. A plurality of ribs 46 radially extend between the inner surface of the flange 42 and the outer surface of the outer ring 45 of the hub 43.

The output unit 50 includes a first member 51 and a second member 52. The first member 51 has a circular disc 53 with a central hole. The circular disc 53 is received inside the flange 42 of the worm wheel 40. An inner toothed ring 54 coaxially and integrally extends from one end surface of the circular disc 53 away from the base wall 41 of the worm wheel 40. The second member 52 includes an outer toothed ring 55 and an output coupling 56 coaxially and integrally extending from one end surface of the outer toothed ring 55 away from the circular disc 53. The outer toothed ring 55 is received in and engaged with the inner tooth ring 54 such that the second member 52 is able to rotate with the first member 51.

The damper 60 is made of resiliently deformable material such as rubber and is axially disposed between the worm wheel 40 and the output unit 50. The damper 60 has a circular ring configuration and includes a plurality of main parts 61 spaced in the circumferential direction and a plurality of openings 62 formed in the main parts 61. Inner radial ends of adjacent main parts 61 are connected to each other via a bridge 63. The damper 60 is arranged between the outer surface of the outer ring 45 of the hub 43 and the inner surface of the flange 42 with each main part 61 being arranged between adjacent ribs 46 of the worm wheel 40 such that the damper 60 rotates with the worm wheel 40. A plurality of pins 57 project from the axial end surface of the circular disc 53 remote from the inner toothed ring 54 and are disposed in the openings 62 in the main parts 61 such that rotation of the damper 60 is able to cause rotation of the circular disc 53. Preferably, a plurality of small protrusions 64 project from axial end surfaces of the main parts 61 facing the circular disc 53 such that the contact area between the damper 60 and the circular disc 53 is reduced to balance the noise and vibration between them.

The main shaft 70 is perpendicular to the worm shaft 26 of the motor 22 and fixed to the gearbox housing 32. Preferably, the gearbox housing 32 is over-molded on the main shaft. The worm wheel 40, the first member 51, and the second member 52 are coaxial with and rotatably sleeved on the main shaft 70. The inner toothed ring 54 of the first member 51 and the second member 52 pass through a through hole of the gearbox cover 34. An intermediate coupling 19 directly or indirectly connected with the kneading tool 18 is coupled to the output coupling 56 of the second member 52 to transmit the rotation of the reduction gear unit 30 to the kneading tool 18.

Preferably, the worm wheel 40 is made of low heat resistant material such as resin. Preferably, the first member 51 is made of a resin which can withstand higher temperatures. The second member 52 is made of metal. The main shaft 70 comprises a metal body 72 and a thermal insulating portion 74 formed on one end of the metal body 72 adjacent the output unit 50. The first member 51 and the second member 52 are sleeved on the thermal insulating portion 74. Preferably, the thermal insulating portion 74 is made of heat resistant plastic, for example, a thermosetting plastic and over-molded on the metal body 72. An aperture 76 for discharging the gas generated during the forming of the thermal insulation portion 74 is formed in the thermal insulating portion 74. A sealing ring 37 is received inside the circular disc 53 and tightly sleeved on the main shaft 70.

In this embodiment, the cost and weight of the motor assembly 20 are relatively low as the worm wheel 40 and the first member 51 are made of resin. Moreover, the worm wheel 40, which is of low heat resistant material, will not be negatively influenced by heat from the kneading tool 18 as heat transmitted to the second member 52 from the kneading tool 18 via the intermediate coupling 19 is not transmitted to the worm wheel 40 because of the thermal insulating portion 74. Thirdly, the motor 22 is isolated from vibrations generated by the kneading tool 18 as the vibrations can be absorbed by the damper 60. Fourthly, the motor assembly 20 has a compact structure in the axial direction of the main shaft 70 such that the height of the bread maker 10 can be reduced.

A low heat resistance material is generally considered to be a material which can only withstand temperatures up to about 100° C. As an example, the preferred material of the worm wheel 40 is polyoxymethylene (POM), which can withstand a maximum temperature of 75° C. The preferred material of the first member 51 and the thermal insulating portion 74, is glass fiber filled Nylon 66 (PA66+GF) or glass fiber filled polyphthal amide (PPA+GF), which can withstand 250° C.

In the description and claims of the present application, each of the verbs “comprise”, “include”, “contain” and “have”, and variations thereof, are used in an inclusive sense, to specify the presence of the stated item but not to exclude the presence of additional items.

Although the invention is described with reference to one or more preferred embodiments, it should be appreciated by those skilled in the art that various modifications are possible. Therefore, the scope of the invention is to be determined by reference to the claims that follow.

For example, it should be understood that the motor assembly 20 may be applied to other types of food processors besides bread makers.

1. A motor assembly, comprising an electric motor and a speed reduction gear unit driven by the motor, the speed reduction gear unit comprising a main shaft and an output unit, wherein the main shaft comprises a metal body and an thermal insulating portion formed on the metal body, the output unit being at least partly sleeved on the thermal insulating portion to prevent heat on the output unit from being transmitted to the metal body.

2. The motor assembly of claim 1, wherein the thermal insulating portion is over-molded on the metal body.

3. The motor assembly of claim 1, wherein the output unit comprises a first member and a second member engaged with the first member, the second member being made of metal and sleeved on the thermal insulating portion.

4. The motor assembly of claim 3, wherein the first member is made of low heat resistant material.

5. The motor assembly of claim 4, wherein a sealing ring is received inside the first member and tightly sleeved on the main shaft.

6. A food processor, comprising:
a container;
a working piece for processing food material in the container; and
a motor assembly for driving the working piece, the motor assembly comprising an electric motor and a speed reduction gear unit connected between the motor and the working piece;
wherein the speed reduction gear unit comprises a damper for isolating the motor from vibrations from the working piece.

7. The food processor of claim 6, wherein the speed reduction gear unit further comprises a stationary main shaft, and a toothed wheel and an output unit which are rotatably sleeved on the main shaft, the damper being axially arranged between the toothed wheel and the output unit and transmitting the rotation of the toothed wheel to the output unit.

8. The food processor of claim 7, wherein the motor has a worm shaft and the toothed wheel is engaged with the worm shaft.

9. The food processor of claim 7, wherein the main shaft comprises a metal body and a thermal insulating portion formed on the metal body, the output unit being at least partly sleeved on the thermal insulating portion.

10. The food processor of claim 9, wherein the output unit comprises a first member and a second member separately formed and engaged with the first member, the second member being made of metal and sleeved on the thermal insulating portion, and the toothed wheel is made of low heat resistant material.

11. The food processor of claim 10, wherein the first member is coupled to the damper.

12. The food processor of claim 10, wherein a sealing ring is received inside the first member and tightly sleeved on the main shaft.

13. The food processor of claim 7, wherein a plurality of small protrusions are projected from one axial end surface of the damper facing the output unit to contact an adjacent axial end surface of the output unit.

14. A bread maker, comprising:
a casing;
a container arranged in the casing;
a baking chamber with a heater for heating the container;
a kneading tool rotatably disposed in the container for kneading bread material; and
a motor assembly comprising an electric motor and a speed reduction gear unit connected between the motor and the kneading tool;
wherein the motor has a worm shaft, and the speed reduction gear unit has a worm wheel and a main shaft, the worm wheel being sleeved on the main shaft and engaged with the worm shaft.

15. The bread maker of claim 14, wherein the kneading tool is coaxial with the main shaft.

16. The bread maker of claim 14, wherein the speed reduction gear unit comprises a damper for isolating the motor from vibrations from the kneading tool.

17. The bread maker of claim 16, the speed reduction gear unit further comprises an output unit, wherein the main shaft is stationary and the worm wheel and the output unit are rotatably sleeved on the main shaft, and the damper is disposed between the worm wheel and the output unit to transfer the rotation of the worm wheel to the output unit.

18. The bread maker of claim 17, wherein the main shaft comprises a metal body and a thermal insulating portion formed on the metal body, the output unit being at least partly sleeved on the thermal insulating portion.

19. The bread maker of claim 18, wherein the output unit comprises a first member and a second member separately formed and engaged with the first member, the second member being made of metal and sleeved on the thermal insulating portion, and the worm wheel is made of low heat resistant material, and the first member is coupled to the worm wheel via the damper.

20. The bread maker of claim 17, wherein a plurality of small protrusions project from one axial end surface of the damper facing the output unit to contact an adjacent axial end surface of the output unit.
